(19) United States
(12) Patent Application Publication
(10) Pub. No.: US 2013/0342325 A1
(43) Pub. Date: Dec. 26, 2013

(54) FIREFIGHTING APPARATUS CHECKING SYSTEM AND METHOD

(71) Applicant: HON HAI PRECISION INDUSTRY CO., LTD., New Taipei (TW)

(72) Inventors: SHAO-WEN WANG, New Taipei (TW); SHIH-CHENG WANG, New Taipei (TW)

(21) Appl. No.: 13/917,091

(22) Filed: Jun. 13, 2013

(30) Foreign Application Priority Data
Jun. 21, 2012 (TW) 101122235

(51) Int. Cl. G06K 19/06

(52) U.S. Cl. CPC G06K 19/06
USPC 340/10.1

(57) ABSTRACT

A cloud server of a data center being used to check firefighting apparatuses. The cloud server sends an electronic map to the electronic device if the electronic device is permitted to access the cloud server. The cloud server receives a check file corresponding to each firefighting apparatus from the electronic device after a user checks each firefighting apparatus. The cloud server amends a color of an icon of the firefighting apparatus in the electronic map according to the check file corresponding to the firefighting apparatus.

### BACKGROUND

1. Technical Field

The embodiments of the present disclosure relate to firefighting apparatuses, and particularly to a firefighting apparatus checking system and method via cloud computing.

2. Description of Related Art

A building includes firefighting equipment (e.g., a fire hydrant or a fire extinguisher) in case of fire. The firefighting equipment needs to be tested periodically (e.g., every week), to ensure the firefighting equipment is functional. However, most test includes a user visually inspecting and manually writing a test result (e.g., pass or fail) of the firefighting equipment in a notebook. If the notebook is lost, the check result is lost. Therefore, there is room for improvement in the art.

### BRIEF DESCRIPTION OF THE DRAWINGS

FIG. 1 is a system view of one embodiment of a firefighting apparatus checking system.

FIG. 2 is a block diagram of one embodiment of a cloud server included in FIG. 1.

FIG. 3 is a flowchart of one embodiment of a firefighting apparatus checking method.

FIG. 4 illustrates one embodiment of an electronic map.

### DETAILED DESCRIPTION

The disclosure is illustrated by way of examples and not by way of limitation in the figures of the accompanying drawings in which like references indicate similar elements. It should be noted that references to “an” or “one” embodiment in this disclosure are not necessarily to the same embodiment, and such references mean “at least one.”

In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

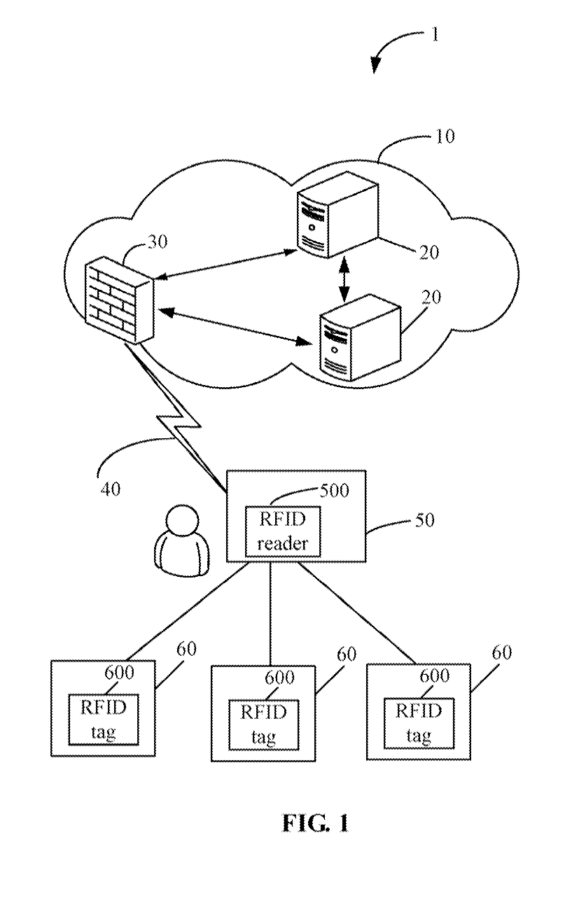

FIG. 1 is a block diagram of one embodiment of a firefighting apparatus checking system 1. In this embodiment, the firefighting apparatus checking system 1 may include a data center 10, a network 40, an electronic device 50 and one or more firefighting apparatuses 60. The firefighting apparatus checking system 1 is used to check the working state of the firefighting apparatuses 60.

The data center 10 is located behind a firewall 30 and connected to the network 40. The network 40 may be, but is not limited to, a wide area network (e.g., the Internet) or a local area network. The firewall 30 is used to protect the data center 10 from unauthorized access and secure the information of the data center 10. The data center 10 is designed for cloud computing capability and capacity and includes a plurality of cloud servers 20.

The cloud server 20 includes a dynamic host configuration protocol (DHCP) server. The DHCP server assigns internet protocol (IP) addresses to the electronic device 50. The cloud server 20 further sets a password (e.g., 1234$) and a name (e.g., apple) for enabling the electronic device 50 to access the data center 10. The cloud server 20 also provides an access privilege for the electronic device 50 according to the assigned IP address, the password and the name. Additionally, the cloud server 20 may be a personal computer (PC), a network server, or other data-processing apparatus. Further details of the cloud server 20 will be described below.

The electronic device 50 is connected to the network 40. The electronic device 50 may be, but is not limited to, a smart phone, a tablet computer, a laptop computer, or any other portable devices. The electronic device 50 may provide a user interface for a user to access the data center 10 to control one or more operations of the cloud server 100. The user may input the password and the name using an input device (e.g., a keyboard) into the user interface on a display device of the electronic device 50 to access the data center 10.

The electronic device 50 includes a radio frequency identification (RFID) reader 500. The firefighting apparatus 60 includes a RFID tag 600. The RFID tag 600 stores attribute information corresponding to the firefighting apparatus 60. The attribute information may include, but is not limited to, a serial number, a location, an expiration date, a name, a specification, an introduction of the firefighting apparatus 60. The RFID reader 500 obtains the attribute information when the RFID reader 500 is close to an allowable range (e.g., 0-10 centimeters) of the RFID tag 600. The firefighting apparatus 60 may be, but are not limited to, a fire hydrant or a fire extinguisher. Additionally, the electronic device 50 also transmits the attribute information to the cloud server 20.

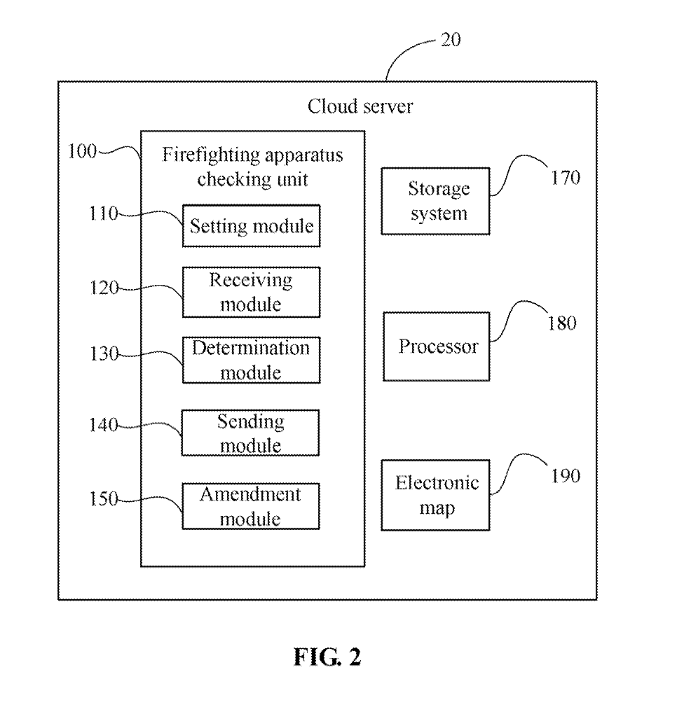

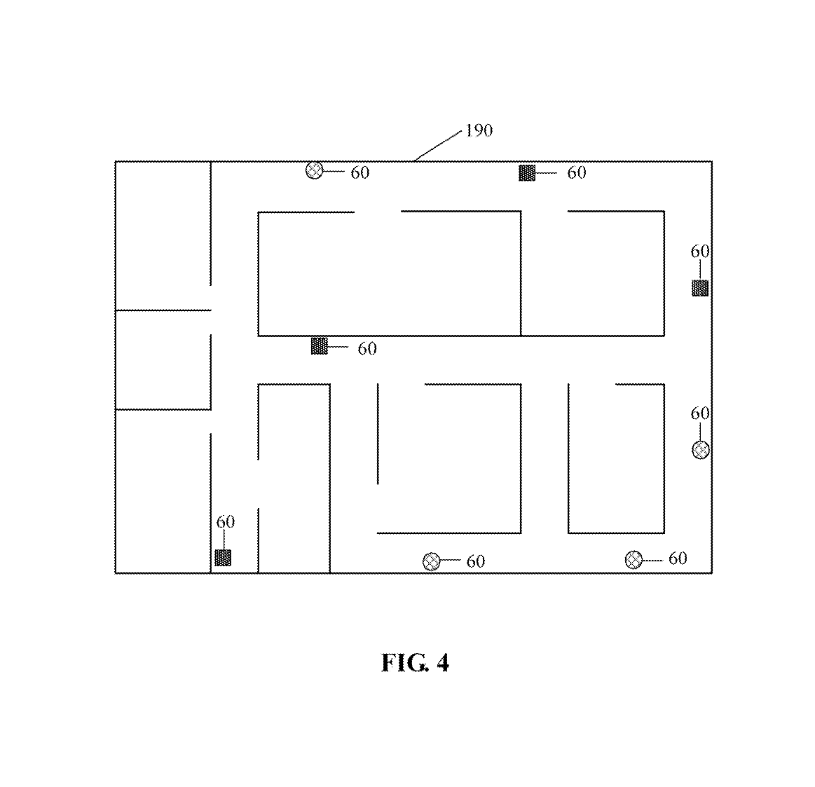

FIG. 2 is a block diagram of one embodiment of the cloud server 20. The cloud server 20 includes a firefighting apparatus checking unit 100. The firefighting apparatus checking unit 100 is used to check the firefighting apparatuses 60. In one embodiment, the cloud server 20 includes a storage system 170, and at least one processor 180. In one embodiment, the firefighting apparatus checking unit 100 includes a setting module 110, a receiving module 120, a determination module 130, a sending module 140, and an amendment module 150. The modules 110-150 may include computerized code in the form of one or more programs that are stored in a storage system 170. The computerized code includes instructions that are executed by the at least one processor 180 to provide functions for the modules 110-140. The storage system 170 may be a cache or a memory, such as an EPROM memory chip, hard disk drive (HDD), or flash memory stick. Additionally, the cloud server 20 includes an electronic map 190. The electronic map 190 shows an icon of each firefighting apparatus 60 as shown in FIG. 4, and the icon of each firefighting apparatus 60 indicates the location of the firefighting apparatus 60. The user can easily finds the firefighting apparatus 60 according to the electronic map 190. Different colors are assigned to the icons to indicate whether the firefighting apparatuses 60 work normally or abnormally. For example, if an icon of a firefighting apparatus 60 is red, it indicates that the firefighting apparatus 60 works abnormally. If the icon of the firefighting apparatus 60 is green, it indicates that the firefighting apparatus 60 works normally.

The setting module 110 sets identification information in the cloud server 100 of the data center 10. In one embodiment, the identification information may include the IP address, the password and the name of the user. The identification information is also stored in the storage system 170.

The receiving module 120 receives an access request from the electronic device 50. In one embodiment, the access request includes the IP address of the electronic device 50, the password and name inputted in the user-interface of the electronic device 50 by the user. In other words, the access request includes identification information from the electronic device 50.

The determination module 130 determines if the identification information in the access request matches the identification information stored in the storage system 170. In one embodiment, the determination module 140 compares the identification information that is stored in the storage system 180 with the identification information in the access request, if the identification information in the access request is the same as the identification information stored in the storage system 170, the electronic device 50 is permitted to access the cloud server 20 of the data center 10. Otherwise, if the identification information in the access request is different from the identification information stored in the storage system 170, the electronic device 50 is not permitted to access the cloud server 20 of the data center 10.

The sending module 140 sends the electronic map 190 to the electronic device 50 when the electronic device 50 is permitted to access the cloud server 20 of the data center 10. The electronic map 190 is displayed on the display device of the electronic device 50, and the electronic map 190 directs the user to the position of the firefighting apparatus 600.

The receiving module 120 receives a check file corresponding to each firefighting apparatus 60 from the electronic device 50 after a user checks each firefighting apparatus 60. In one embodiment, when the user reaches the position of the firefighting apparatus 60, the user uses the RFID reader 500 of the electronic device 50 to approach the RFID tag 600 of the firefighting apparatus 60. The RFID reader 500 obtains the attribute information corresponding to the firefighting apparatus 60. Additionally, the electronic device 50 generates a table for the user to fill a check result. For example, if the firefighting apparatus 600 works normally, the user fills the word “pass” in the table. If the firefighting apparatus 600 works abnormally, the user fills the word “fail” in the table. The check file is integrated with the attribute information and the table in the electronic device 50 and is sent to the cloud server 20.

The amendment module 140 amends the color of the icon of the firefighting apparatus 600 in the electronic map 190 according to the check file corresponding to the firefighting apparatus 600. For example, if the check file corresponding to the firefighting apparatus 600 indicates that the firefighting apparatus 600 works abnormally, the amendment module 140 amends the color of the icon of the firefighting apparatus 600 from green to red. If the check file corresponding to the firefighting apparatus 600 indicates that the firefighting apparatus 600 works normally, the amendment module 140 amends the color of the icon of the firefighting apparatus 600 from red to green.

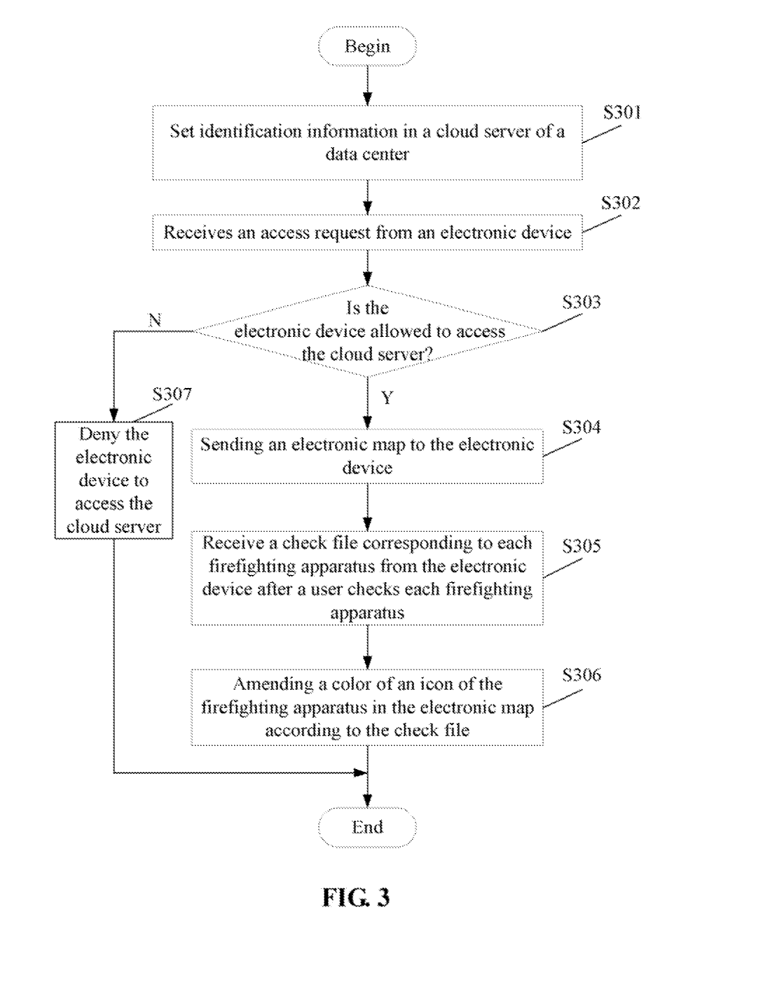

FIG. 3 is a flowchart of one embodiment of a firefighting apparatus checking method. Depending on the embodiment, additional steps may be added, others deleted, and the ordering of the steps may be changed.

In step S301, the setting module 110 sets identification information in the cloud server 100 of the data center 10. As mentioned above, the identification information may be the IP address (e.g., 10.10.10.10), the password (e.g., 1234$) and the name (e.g., apple).

In step S302, the receiving module 120 receives an access request from the electronic device 50. In one embodiment, if the user inputs the password and name in the user-interface of the electronic device 50, the access request is immediately generated and integrated with the IP address of the electronic device 50, password and name of the user. In other words, the access request includes identification information from the electronic device 50.

In step S303, the determination module 130 determines if the identification information in the access request matches the identification information stored in the storage system 170. In one embodiment, the determination module 140 compares the identification information that is stored in the storage system 180 with the access request, if the identification information in the access request is the same as the identification information stored in the storage system 170, the electronic device 50 is permitted to access the cloud server 20 of the data center 10, the procedure goes to step S304. Otherwise, if the identification information in the access request is different from the identification information stored in the storage system 170, the electronic device 50 is not permitted to access the cloud server 20 of the data center 10, the procedure goes to step S307.

In step S304, the sending module 140 sends the electronic map 190 to the electronic device 50. The electronic map 190 is displayed in the display of the electronic device 50, and the user can find each firefighting apparatus 600 according to the electronic map 190.

In step S305, the receiving module 120 receives a check file corresponding to each firefighting apparatus 60 from the electronic device 50 after a user checks each firefighting apparatus 60. In one embodiment, when the user reaches to the position of the firefighting apparatus 60, the user uses the RFID reader 500 of the electronic device 50 to approach the RFID tag 600 of the firefighting apparatus 60. The RFID reader 500 obtains the attribute information corresponding to the firefighting apparatus 60. The user manually checks the firefighting apparatus 600, for example, the user checks the fire extinguisher to determine if a hose, a nozzle, and connections are free from damage, and determine if the fire extinguisher expires by seeing the expiration date. Additionally, the electronic device 50 generates a table for the user to fill a check result. For example, if the firefighting apparatus 600 works normally, the user fills the word “pass” in the table. If the firefighting apparatus 600 works abnormally, the user fills the word “fail” in the table. The check file is integrated with the attribute information and the table in the electronic device 50 and is sent to the cloud server 20.

In step S306, the amendment module 140 amends the color of the icon of the firefighting apparatus 600 in the electronic map 190 according to the check file corresponding to the firefighting apparatus 600. If the check result in the check file corresponding to the firefighting apparatus 600 is “fail,” the amendment module 140 amends the color of the icon of the firefighting apparatus 600 to red. If the check result in the check file corresponding to the firefighting apparatus 600 is “pass,” the amendment module 140 amends the color of the icon of the firefighting apparatus 600 to green.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A cloud server of a data center, the cloud server in electronic communication with an electronic device, the cloud server comprising:
at least one processor; and
a storage system, which stores identification information of the electronic device, an electronic map, and one or more programs that are executed by the at least one processor to perform a firefighting apparatus checking method, the method comprising:
receiving an access request from the electronic device;
determining if identification information contained in the access request matches the identification information stored in the storage system;
sending the electronic map to the electronic device, in response to a determination that the identification information contained in access request matches the identification information stored in the storage system;
receiving a check file corresponding to each firefighting apparatus from the electronic device after a user checks each firefighting apparatus; and
amending a color of an icon of the firefighting apparatus in the electronic map according to the check file corresponding to the firefighting apparatus.

2. The cloud server of the data center of claim 1, wherein the identification information comprises an IP address of the electronic device, a password and a name of the user.

3. The cloud server of the data center of claim 1, wherein the electronic device comprises a radio frequency identification reader, and the firefighting apparatus comprises a radio frequency identification tag.

4. The cloud server of the data center of claim 3, wherein the radio frequency identification tag stores attribute information corresponding to the firefighting apparatus, and the attribute information corresponding to the firefighting apparatus comprises a serial number, a location, an expiration date, a name, a specification, and an introduction of the firefighting apparatus.

5. The cloud server of the data center of claim 4, wherein the radio frequency identification reader obtains the attribute information corresponding to the firefighting apparatus from the radio frequency identification tag.

6. The cloud server of the data center of claim 4, wherein the check file is integrated with the attribute information corresponding to the firefighting apparatus and a table, and the table is used for the user to fill a check result.

7. A firefighting apparatus checking method implemented by a cloud server of a data center, the cloud server in electronic communication with an electronic device, the method comprising:
receiving an access request from the electronic device;
determining if identification information in the access request matches the identification information stored in a storage system of the cloud server;
sending an electronic map to the electronic device, in response to a determination that the identification information in the access request matches the identification information stored in the storage system of the cloud server;
receiving a check file corresponding to each firefighting apparatus from the electronic device after a user checks each firefighting apparatus; and
amending a color of an icon of the firefighting apparatus in the electronic map according to the check file corresponding to the firefighting apparatus.

8. The method of claim 7, wherein the identification information comprises an IP address of the electronic device, a password and a name of the user.

9. The method of claim 7, wherein the electronic device comprises a radio frequency identification reader, and the firefighting apparatus comprises a radio frequency identification tag.

10. The method of claim 9, wherein the radio frequency identification tag stores attribute information corresponding to the firefighting apparatus, and the attribute information corresponding to the firefighting apparatus comprises a serial number, a location, an expiration date, a name, a specification, and an introduction of the firefighting apparatus.

11. The method of claim 10, wherein the radio frequency identification reader obtains the attribute information corresponding to the firefighting apparatus from the radio frequency identification tag.

12. The method of claim 10, wherein the check file is integrated with the attribute information corresponding to the firefighting apparatus and a table, and the table is used for the user to fill a check result.

13. A non-transitory computer-readable medium having stored thereon instructions that, when executed by a cloud server of a data center, the cloud server in electronic communication with an electronic device, causing the cloud server to perform a firefighting apparatus checking method, the method comprising:
receiving an access request from the electronic device;
determining if identification information in the access request matches the identification information stored in a storage system of the cloud server;
sending an electronic map to the electronic device, in response to a determination that the identification information in the access request matches the identification information stored in the storage system of the cloud server;
receiving a check file corresponding to each firefighting apparatus from the electronic device after a user checks each firefighting apparatus; and
amending a color of an icon of the firefighting apparatus in the electronic map according to the check file corresponding to the firefighting apparatus.

14. The non-transitory computer-readable medium of claim 13, wherein the identification information comprises an IP address of the electronic device, a password and a name of the user.

15. The non-transitory computer-readable medium of claim 13, wherein the electronic device comprises a radio frequency identification reader, and the firefighting apparatus comprises a radio frequency identification tag.

16. The non-transitory computer-readable medium of claim 15, wherein the radio frequency identification tag stores attribute information corresponding to the firefighting apparatus, and the attribute information corresponding to the firefighting apparatus comprises a serial number, a location, an expiration date, a name, a specification, and an introduction of the firefighting apparatus.

17. The non-transitory computer-readable medium of claim 16, wherein the radio frequency identification reader obtains the attribute information corresponding to the firefighting apparatus from the radio frequency identification tag.

18. The non-transitory computer-readable medium of claim 16, wherein the check file is integrated with the attribute information corresponding to the firefighting apparatus and a table, and the table is used for the user to fill a check result.
